(19) United States
(12) Patent Application Publication
(10) Pub. No.: US 2025/0353582 A1
(43) Pub. Date: Nov. 20, 2025

(54) METHOD AND DEVICE FOR RELAYING ENGINE CONTROL MESSAGE

(71) Applicant: AVIKUS CO., LTD., Seoul (KR)

(72) Inventors: Ji Hoon YOO, Seoul (KR); Won Jun CHA, Seoul (KR); Jun Sik LEE, Seoul (KR)

(21) Appl. No.: 19/085,944

(22) Filed: Mar. 20, 2025

Related U.S. Application Data
(63) Continuation of application No. PCT/KR2024/096845, filed on Dec. 12, 2024.

(30) Foreign Application Priority Data
May 17, 2024 (KR) 10-2024-0064515

(51) Int. Cl. B63B 79/40; B63B 49/00; G05D 1/222; G05D 109/30

(52) U.S. Cl. CPC B63B 79/40; B63B 49/00; G05D 1/222; B63B 2213/00; G05D 2109/30

(57) ABSTRACT

A device for relaying an engine control message includes at least one memory and at least one processor, wherein the processor determines whether a navigation mode of a ship is a manual navigation mode or an autonomous navigation mode based on a signal received from an autonomous navigation processing device, outputs a first message to an internal communication network in response to the navigation mode of the ship being the manual navigation mode, generates a second message by converting the first message stored in the at least one memory, and then outputs the second message to the internal communication network in response to the navigation mode of the ship being the autonomous navigation mode.

### CROSS-REFERENCE TO RELATED APPLICATION

This application is a Bypass Continuation Application based on International Patent Application PCT/KR2024/096845 filed on Dec. 12, 2024, and claims priority under 35 U.S.C. § 119 to Korean Patent Application No. 10-2024-0064515, filed on May 17, 2024, in the Korean Intellectual Property Office, the disclosure of which are incorporated by reference herein in its entirety.

### BACKGROUND

### Field

The present disclosure relates to a method and device for relaying a message from a ship control device and/or an autonomous navigation processing device to an engine.

### Description of the Related Art

In the related art, it has been difficult to identify a state of interconnection between an engine of a ship and various instruments included in the ship. In addition, in order to enable autonomous navigation of a ship, control signals from instruments that change in real time need to be converted and then relayed to an engine, but it is impossible to determine which signal to convert and how to convert it for an arbitrary or any given engine.

Thus, the present disclosure proposes a method of converting control signals of instruments for autonomous navigation of a ship, and relaying the converted control signals to an engine, regardless of the type of the engine.

### SUMMARY

Provided are a method and device for relaying an engine control message. In addition, provided is a non-transitory computer-readable recording medium having recorded thereon a program for causing a computer to execute the method. The objectives of the present disclosure are not limited to those described above, and other objectives may be obtained.

Additional aspects will be set forth in part in the description which follows and, in part, will be apparent from the description, or may be learned by practice of the presented embodiments of the disclosure.

According to an aspect of an embodiment, a method of relaying an engine control message to an engine in an engine interface unit comprising a processor and a memory includes, based on a navigation mode of a ship being a first mode, relaying, by the processor, a first message to an internal communication network, in response to the navigation mode of the ship being a second mode, generating, by the processor, a second message by converting the first message stored in the memory, and injecting, by the processor, the second message into the internal communication network.

According to an aspect of another embodiment, a device includes a memory storing at least one program, and at least one processor configured to execute the at least one program to determine whether a navigation mode of a ship is a manual navigation mode or an autonomous navigation mode, in response to the navigation mode of the ship being the manual navigation mode, output a first message to an internal communication network, and in response to the navigation mode of the ship being the autonomous navigation mode, generate a second message by converting the first message stored in the memory and then output the second message to an internal communication network.

According to an aspect of another embodiment, a non-transitory computer-readable recording medium includes a recording medium recording thereon a program for causing a computer to execute the above-described method.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for describing an example of an autonomous navigation system according to an embodiment;

FIG. 2 is a block diagram for describing an example of a device for relaying an engine control message, according to an embodiment;

FIG. 3 is a flowchart for describing an example of a method of relaying an engine control message, according to an embodiment;

FIG. 4 is a diagram for describing an example of a method of generating a second message by converting a first message, according to an embodiment;

FIGS. 5A and 5B are diagrams for describing an example of relaying an engine control message to an engine, according to an embodiment;

FIG. 6 is a diagram for describing an example of a structure for relaying a message, according to an embodiment; and

FIG. 7 is a diagram for describing another example of a structure for relaying a message, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Terms used in embodiments are selected to align with widely accepted general terms whenever possible, which may vary depending on intentions or precedents of one of ordinary skill in the art, emergence of new technologies, and the like. In addition, in certain cases, there are also terms arbitrarily selected by the applicant, and in this case, the meaning thereof will be defined in detail in the description. Therefore, the terms used herein should be defined based on the meanings of the terms and the details throughout the present description, rather than the simple names of the terms.

Throughout the present specification, when a part “includes” a component, it means that the part may additionally include other components rather than excluding other components as long as there is no particular opposing recitation. In addition, as used herein, terms such as “. . . unit” or “. . . module” denote a unit that performs at least one function or operation, which may be implemented as hardware or software or a combination thereof.

In addition, although terms such as “first” or “second” may be used herein to describe various elements, these elements should not be limited by these terms. These terms may be only used to distinguish one element from another.

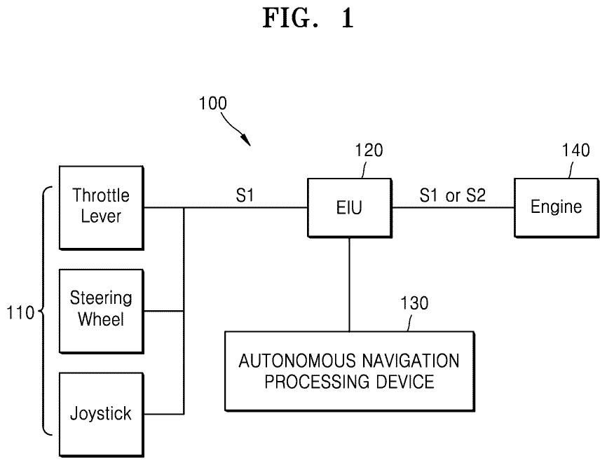

Hereinafter, the present disclosure will be described in detail with reference to the accompanying drawings. In detail, a method of relaying an engine control message according to an embodiment will be described in more detail with reference to FIGS. 1 to 7. The embodiments may, however, be embodied in many different forms and should not be construed as being limited to the embodiments set forth herein.

FIG. 1 is a diagram for describing an example of an autonomous navigation system according to an embodiment.

Hereinafter, an example of an autonomous navigation system will be described with reference to FIG. 1.

Referring to FIG. 1, an autonomous navigation system 100 may include control devices 110 of a ship, an engine interface unit (EIU) 120, an autonomous navigation processing device 130, and an engine 140.

The control devices 110 may include at least one of a throttle lever, a steering wheel, and a joystick. However, the present disclosure is not limited thereto, and the control devices 110 may include other devices of the ship. The control device 110 may be referred to as a helm station in an embodiment.

The EIU 120 may refer to a device configured to obtain signals S1 from the control devices 110 included in the ship through a communication network within the ship, and relay the signals S1 to the engine 140. The signals S1 may include messages or protocols from various control devices 110 included in the ship. The EIU 120 may relay the signals S1 from the control devices 110 to the engine 140 without modification, or may convert the signals S1 from the control devices 110 and then relay the converted signals S2 to the engine 140.

Hereinafter, for convenience of description, when the EIU 120 relays the signals S1 from the control devices 110 without modification, it may be described as ‘relaying the signals’, and when the EIU 120 converts the signals S1 from the control devices 110 and then relays the converted signals S2 to the engine 140, it may be described as ‘injecting the signals’, but the present disclosure is not limited thereto.

The EIU 120 may be a device configured to enable switching between an autonomous navigation mode and a manual navigation mode of the ship, by relaying or injecting the signals S1 from the control devices 110. The EIU 120 may determine whether the current navigation mode of the ship is an autonomous navigation mode or a manual navigation mode, based on a control command received from the autonomous navigation processing device 130. The EIU 120 may also receive, from the autonomous navigation processing device 130, a determined navigation state of the ship. In this case, the EIU 120 may operate based on the determined navigation state. According to an embodiment, the EIU 120 may detect control values that are output from the control devices 110 even when a user is not controlling the control devices 110, and determine that the ship is in the autonomous navigation mode.

For example, when the current navigation state of the ship is the manual navigation mode, the EIU 120 may relay the signals S1 from the control devices 110 to the engine 140 without conversion. As another example, when the current navigation state of the ship is the autonomous navigation mode, the EIU 120 may generate the converted signals S2 by converting the signals S1 output from the control devices 110. The converted signals S2 may be a result of transforming a control signal received from the autonomous navigation processing device 130 to fit the data structure of the signals S1 output from the control devices 110. The EIU 120 may inject the converted signals S2 into an internal communication network.

The EIU 120 may be connected to the control devices 110 and the engine 140 of the ship via the internal communication network. The internal communication network may include a controller area network (CAN). Here, the CAN may refer to an internal communication network of a ship, an automobile, etc. capable of performing data transmission between engine control units (ECUs), controlling various control devices 110, controlling a system, etc., but the present disclosure is not limited thereto, and the internal communication network may refer to any communication network capable of transmitting data between the control devices 110 and the engine 140 of the ship. According to an embodiment, the user may use the EIU 120 to check an interconnection state between the control devices 110, the autonomous navigation processing device 130, and the engine 140.

The autonomous navigation processing device 130 may be a device configured to process control commands from the control devices 110 of the ship for controlling the engine 140 of the ship when the ship is in the autonomous navigation mode. In other words, even when the user is not manipulating the control devices 110, the autonomous navigation processing device 130 may generate a command for controlling the engine 140 of the ship using the command of the control devices 110 of the ship. In addition, the autonomous navigation processing device 130 may transmit a navigation state of the ship to the EIU 120, such that the EIU 120 may operate based on the navigation state of the ship.

The engine 140 may be a device that operates based on control commands from the control devices 110 of the ship. For example, when the ship is in the manual navigation mode, the engine 140 may operate based on a user input for manipulating the control devices 110. As another example, when the ship is in the autonomous navigation mode, the engine 140 may operate based on a control command received from the autonomous navigation processing device 130.

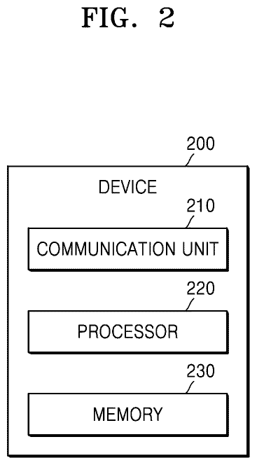

FIG. 2 is a block diagram for describing an example of a device for relaying an engine control message to an engine, according to an embodiment.

Referring to FIG. 2, a device 200 for relaying a message from a ship control device and/or an autonomous navigation processing device to an engine (hereinafter, referred to as the “device 200”) may include a communication unit 210, a processor 220, and a memory 230. The message may include command signals such as adjusting throttle or gear of the engine 140. The device 200 of FIG. 2 may correspond to the EIU 120 of FIG. 1. FIG. 2 illustrates the device 200 including only the components associated with an embodiment. Thus, it is obvious to those skilled in the art that other general-purpose components may also be included in addition to the components illustrated in FIG. 2.

The communication unit 210 may include one or more components for performing wired/wireless communication with an external server or an external device. For example, the communication unit 210 may include a short-range communication unit (not shown) and a mobile communication unit (not shown) for communication with an external server or an external device. The communication unit 210 may include an internal communication network for exchanging signals with the control devices 110 (see FIG. 1) and the engine 140 (see FIG. 1). According to an embodiment, the internal communication network may be a CAN.

The memory 230 is hardware for storing various data processed by the device 200, and may store a program for the processor 220 to perform processing and control. For example, the memory 230 may store various data, such as data obtained by extracting the signal structures used for various engines, and data generated according to an operation of the processor 220. The memory 230 may store a database in which data obtained by extracting the signal structures used for various engines is stored. According to an embodiment, the memory 230 may store only data received from an external server according to the type of an engine equipped in the ship. In addition, the memory 230 may store an operating system (OS) and at least one program (e.g., a program required for the processor 220 to operate).

The memory 230 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 220 controls the overall operation of the device 200. For example, the processor 220 may execute programs stored in the memory 230 to control the overall operation of an input unit (not shown), a display (not shown), the communication unit 210, the memory 230, and the like.

The processor 220 may be implemented using at least one of application-specific integrated circuits (ASICs), digital signal processors (DSPs), digital signal processing devices (DSPDs), programmable logic devices (PLDs), field-programmable gate arrays (FPGAs), controllers, microcontroller units, microprocessors, and other electrical units for performing functions.

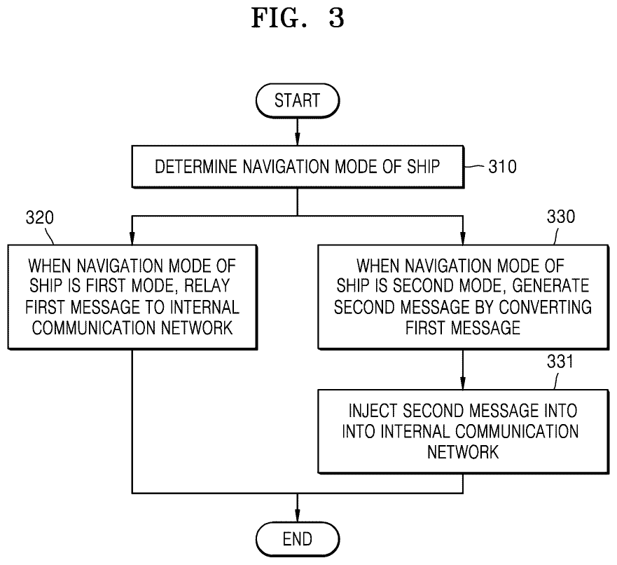

The processor 220 may execute programs stored in the memory 230 to control the operation of the device 200. For example, the processor 220 may perform at least some of operations of a method of delaying a message from a ship control device and/or an autonomous navigation processing device to an engine, which will be described below with reference to FIGS. 3 to 7.

FIG. 3 is a flowchart for describing an example of a method of relaying an engine control message to an engine, according to an embodiment. Hereinafter, an example of a method of relaying an engine control message will be described with reference to FIG. 3.

Referring to FIG. 3, a method of relaying an engine control message may include operations 310 to 331. However, the present disclosure is not limited thereto, and other general-purpose operations other than the operations illustrated in FIG. 3 may be further included in the method of relaying an engine control message. In addition, as described above with reference to FIGS. 1 and 2, at least one of the operations in the flowchart of FIG. 3 may be processed by the processor 220.

In operation 310, the processor 220 may determine a navigation mode of the ship. For example, the processor 220 may obtain information associated with the navigation mode of the ship, and determine the navigation mode of the ship using the obtained information. Here, a first mode may refer to a manual navigation mode, and a second mode may refer to an autonomous navigation mode. In addition, an upper controller may include the autonomous navigation processing device 130 (see FIG. 1).

In operation 320, when the navigation mode of the ship is the first mode, the processor 220 may relay a first message to an internal communication network. Here, the first message may refer to the signals S1 (see FIG. 1) obtained from the control devices 110 (see FIG. 1) of the ship and may be stored in the memory 230. In addition, the internal communication network may be connected to the control devices 110 (see FIG. 1), the EIU 120 (see FIG. 1) and the engine 140 (see FIG. 1) of the ship.

In operation 330, when the navigation mode of the ship is the second mode, the processor 220 may generate a second message by converting the first message. Here, the second message may refer to the signals S2 (see FIG. 1) obtained by converting the signals S1 (see FIG. 1) obtained from the control devices 110 (see FIG. 1) of the ship.

For example, the processor 220 may identify control data included in the first message based on pre-stored data, and generate a second message by modifying the control data based on a control value output from the autonomous navigation processing device. Here, the pre-stored data may include data for identifying control data. The data for identifying control data may include message structures that are input to or output from a plurality of engines, and/or data extracted from the message structures. The pre-stored data may include a database of message signals, each associated with a respective engine of the plurality of engines. The pre-stored data may also be used to construct a database based on data extracted from message structures, with each message structure corresponding to each of the plurality of engines.

Here, the control value output from the autonomous navigation processing device may be an engine control value output from the autonomous navigation processing device. For example, the control value output from the autonomous navigation processing device may include a value for controlling at least one of a steering, a throttle, and a gear. The control value output from the autonomous navigation processing device may be derived through an algorithm. The control value output from the autonomous navigation processing device may be the same as or different from a control value output from the control device 110 (see FIG. 1).

For example, the processor 220 may generate a second message using at least one of a plurality of parameters included in the control data. The control data may include a plurality of parameters. For example, the plurality of parameters may include, but are not limited to, at least one of a byte or bit position, a scale, and an offset.

In operation 331, the processor 220 may inject the generated second message into the internal communication network. Thus, the processor 220 may relay a control message of the ship to the engine by relaying the first message to the internal communication network according to the navigation mode of the ship, or by injecting the second message generated by converting the first message into the internal communication network.

As an additional example, the processor 220 may switch a message relay circuit of the internal communication network to relay the first message, based on an error of the autonomous navigation processing device, directly to the engine.

Here, the error of the device may include, but is not limited to, an error in the autonomous navigation system of the ship, a software malfunction, a power failure (or power disconnection), and the like.

As another additional example, the processor 220 may change the navigation mode of the ship based on a user input for manipulating at least one control device included in the ship.

For example, the processor 220 may obtain a user input for manipulating a control device, derive an accumulated value of position changes of the control device based on the obtained user input, and change the navigation mode of the ship based on the accumulated value of position changes. In addition, the processor 220 may determine whether the accumulated value of position changes is greater than or equal to a preset value, and in response to determining that the accumulated value of position changes is greater than or equal to the preset value, change the navigation mode of the ship from the second mode to the first mode.

Here, the processor 220 may derive an hourly position change amount of the control device based on the obtained user input, and change the navigation mode of the ship based on the derived hourly position change amount.

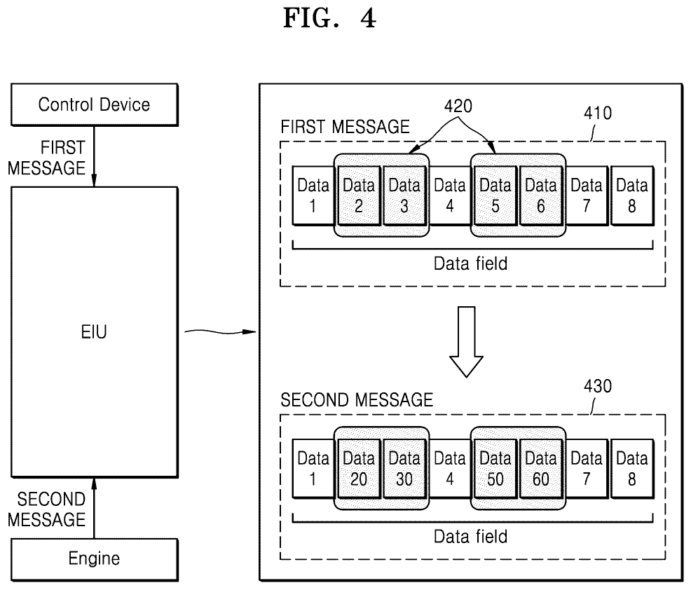

FIG. 4 is a diagram for describing an example of a method of generating a second message by converting a first message, according to an embodiment. Hereinafter, an example in which, when the navigation mode of the ship is the autonomous navigation mode, the processor 220 injects a second message generated by converting a first message into the internal communication network will be described with reference to FIG. 4.

Referring to FIG. 4, when the navigation mode of the ship is the autonomous navigation mode, the processor 220 may convert a first message 410 to generate a second message 430. Here, the first message 410 may be a raw CAN frame, and the second message 430 may be a modified CAN frame. The term ‘message’ in the present disclosure may refer to a CAN frame (or data protocol).

The processor 220 may identify control data 420 included in the first message 410 based on pre-stored data. The processor 220 may identify the control data 420 for an instrument to be controlled, based on the pre-stored data. Here, the control data 420 is data included in the CAN frame, specifically in a data field thereof, and control data for each of a plurality of instruments may be included (or stored) in a particular field. The control data may include data in a field associated with engine control from among the data fields included in the CAN frame.

The processor 220 may identify the control data 420 in the first message 410 for an arbitrary engine using the pre-stored data. The pre-stored data may be data extracted from the message structure output from each of a plurality of engines. The pre-stored data may include control data included in a data field of the CAN frame. The pre-stored data may be data generated based on the structure of the first message. The pre-stored data may vary depending on the type of an engine, and may include the control data 420 for controlling the engine. The pre-stored data may include information about the position and size of control data for a particular instrument from among the data included in the data fields of the first message 410.

For example, the pre-stored data may include information about at least one of a byte or bit position, a scale, and an offset of control data included in a data field. For example, the pre-stored data may include data indicating that control data exists in the m-th data field of the data fields within a first message transmitted to a first engine, and that control data exists in the n-th data field of the data fields within a first message transmitted to a second engine, wherein m and n are natural numbers greater than or equal to 1. The pre-stored data may be data that has been stored by the user in the memory 230, a database, a ship-based server, or a land-based server.

According to an embodiment, the pre-stored data may include a result of determining whether a packet type is multi-packet or single packet, by using continuously obtained log data. When the obtained log data is multi-packet, multiple packets may be merged into a single packet. Thus, the user may identify control data from the single packet of data. The pre-stored data may be obtained in various manners.

The processor 220 may convert the control data 420 included in the first message 410 to generate the second message 430. In detail, the processor 220 may generate the second message 430 using at least one of a plurality of parameters of the control data 420. Here, the plurality of parameters may include a byte or bit position, a scale, and an offset. Thus, the processor 220 may generate the second message 430 by modifying at least one of the byte or bit position, the scale, and the offset of the control data 420, based on a control value of the autonomous navigation processing device 130 (see FIG. 1).

For example, when the processor 220 obtains control values for a throttle and a steering, the processor 220 may identify which position (e.g., which data field) within the data fields of the first message 410 contains the control data 420 for the throttle and the steering, based on the pre-stored data. The processor 220 may change a value of the data field of the first message, in which control data 420 for the throttle and the steering exists, to a value output from the autonomous navigation processing device 130 (see FIG. 1). The processor 220 may generate the second message 430 by converting the identified control data 420 for the throttle and the steering, based on a control value obtained from the autonomous navigation processing device 130 (see FIG. 1).

For example, the processor 220 may generate the second message 430 by internally modulating data in a particular data field from among the data fields of the first message 410, i.e., the raw CAN frame, and injecting a control message or an engine control command. Thus, the processor 220 may generate the second message 430 by modulating only the control data 420 in a particular data field while maintaining the raw CAN frame and data other than in the particular field.

For example, the processor 220 may use, for generating the second message 430, data associated with control from among the data included in the raw CAN frame, and may use, for linking with an upper controller, data not associated with control by monitoring it through data parsing.

As an additional example, the processor 220 or an external server may identify data transmitted and received within the internal communication network connected to the control devices and the engine of the ship, by analyzing correlations between data in the internal communication network, based on an analysis algorithm. In addition, when the external server analyzes correlations between data, the processor 220 may obtain analyzed data from the external server, and identify data within the internal communication network.

Here, the analysis algorithm may be an analysis sequence that is programmed by the user in advance. In addition, the processor 220 may use, as the analysis algorithm, artificial intelligence such as machine learning or deep learning. For example, the processor 220 may analyze raw data to identify control data of the autonomous navigation processing device.

In addition, the processor 220 may identify the structure of a message by deriving a plurality of parameters (e.g., a byte or bit position, a scale, or an offset) from the identified control data. Thus, the processor 220 may store (or update) the structure of the derived parameters or message in the memory 230 or a database.

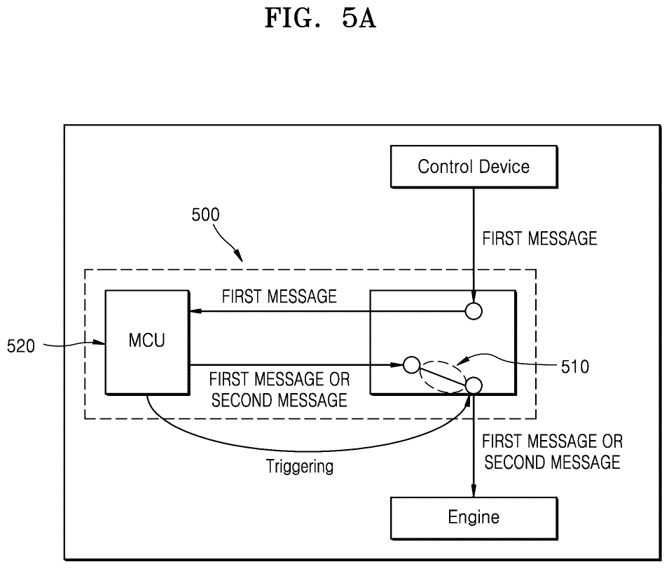

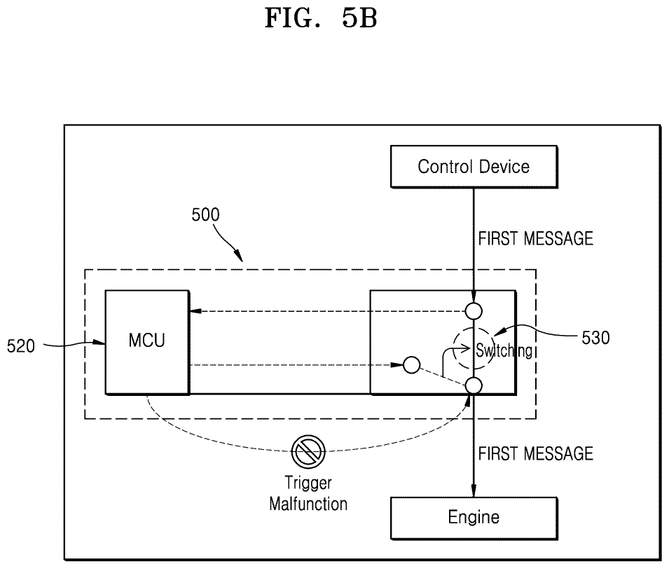

FIGS. 5A and 5B are diagrams for describing an example of relaying an engine control message to an engine, according to an embodiment. Hereinafter, an example of a method, performed by the processor 220, of relaying an engine control message will be described with reference to FIGS. 5A and 5B. Here, an EIU 500 may include at least one multican control unit (MCU) 520, and the MCU 520 may be a processor configured to control the operation of the EIU 500. In addition, the MCU 520 may be the processor 220 described above with reference to FIG. 2, but is not limited thereto, and may refer to a separate processor.

Referring to FIG. 5A, when the ship is normally navigating in the first mode (or the manual navigation mode) or the second mode (or the autonomous navigation mode), the processor 220 may relay a first message or a second message to the engine using a first message relay circuit 510 of the internal communication network.

For example, when the navigation mode of the ship is the manual navigation mode, the processor 220 may relay an original message obtained from a control device, i.e., a first message, to the engine without converting it.

As another example, when the navigation mode of the ship is the autonomous navigation mode, the processor 220 may generate a second message by converting the first message based on a control value obtained from the autonomous navigation processing device, and relay the generated second message to the engine.

For example, even when the ship is navigating in the autonomous navigation mode, the processor 220 may change the navigation mode of the ship based on a user input for manipulating at least one control device included in the ship.

For example, the processor 220 may obtain a user input for manipulating a control device, derive an accumulated value of position changes of the control device based on the user input, and change the navigation mode of the ship based on the accumulated value of position changes. In addition, the processor 220 may determine whether the accumulated value of position changes is greater than or equal to a preset value, and in response to determining that the accumulated value of position changes is greater than or equal to the preset value, change the navigation mode of the ship from the autonomous navigation mode second mode to the manual navigation mode. Here, the processor 220 may derive an hourly position change amount of the control device based on the obtained user input, and change the navigation mode of the ship based on the derived hourly position change amount.

As an additional example, the processor 220 may continuously detect whether the user is controlling an instrument and continuously switch the navigation mode of the ship. In other words, the processor 220 may detect control of a control device by the user, and switch the navigation mode of the ship from the autonomous navigation mode to the manual navigation mode, and when control of a control device by the user is not detected even after the navigation mode is switched to the manual navigation mode, the processor 220 may switch the navigation mode of the ship from the manual navigation mode back to the autonomous navigation mode. Thus, when performing auto-docking of the ship, the processor 220 may continuously and repeatedly switch the navigation mode.

Meanwhile, the difference between switching the navigation mode based on a user input, which is an accumulated value of position changes of a control device of the ship, and switching the navigation mode based on a user input during automatic docking of the ship is that, in the former case, the processor 220 switches the navigation mode only when the accumulated value of position changes of the control device of the ship is greater than or equal to a preset value. In the latter case, during automatic docking of the ship, an operation of switching the navigation mode and switching it again may be continuously repeated depending on whether the user controls the control device.

Referring to FIG. 5B, when the ship is in the autonomous navigation mode but cannot navigate normally, the processor 220 may switch the first message relay circuit 510 of the internal communication network to a second message relay circuit 530, and then relay a message to the engine through the second message relay circuit 530 without modification.

For example, when a problem occurs, such as an error in the autonomous navigation processing device, an error in software, or a power failure in the EIU 500, it may be difficult for the ship to navigate in the autonomous navigation mode, and thus, an immediate switch to the manual navigation mode may be required. Thus, the processor 220 may switch the first message relay circuit 510 of the internal communication network to relay a first message directly to the engine. Accordingly, the processor 220 may switch the first message relay circuit 510 to the second message relay circuit 530, and then relay the first message to the engine through the second message relay circuit 530 without modification.

For example, the processor 220 may switch the first message relay circuit 510 to the second message relay circuit 530 immediately upon detecting an error in the autonomous navigation processing device, and then relay the first message as is to the engine through the second message relay circuit 530.

Meanwhile, examples of errors in the autonomous navigation processing device that are detected by the processor 220 are as follows.

For example, the processor 220 may detect whether controllers are operating in conjunction with each other, and when the controllers are unable to communicate with each other, detect this situation as an error in the device. In addition, when a primary MCU and a secondary MCU are unable to communicate with each other, the processor 220 may detect this situation an error in the device. In addition, when an error occurs in a main thread of the MCU 520, the processor 220 may detect this situation as an error in the device. In addition, the processor 220 may detect a linkage state of each node, and when a node to which a message is assigned is not linked, detect this situation as an error in the device. In addition, when transmission of messages between nodes takes longer than a preset time period, the processor 220 may detect this situation an error in the device.

For example, even when the device is powered off, the processor 220 may enable message transmission between an ECU and the engine via a solid-state relay (SSR).

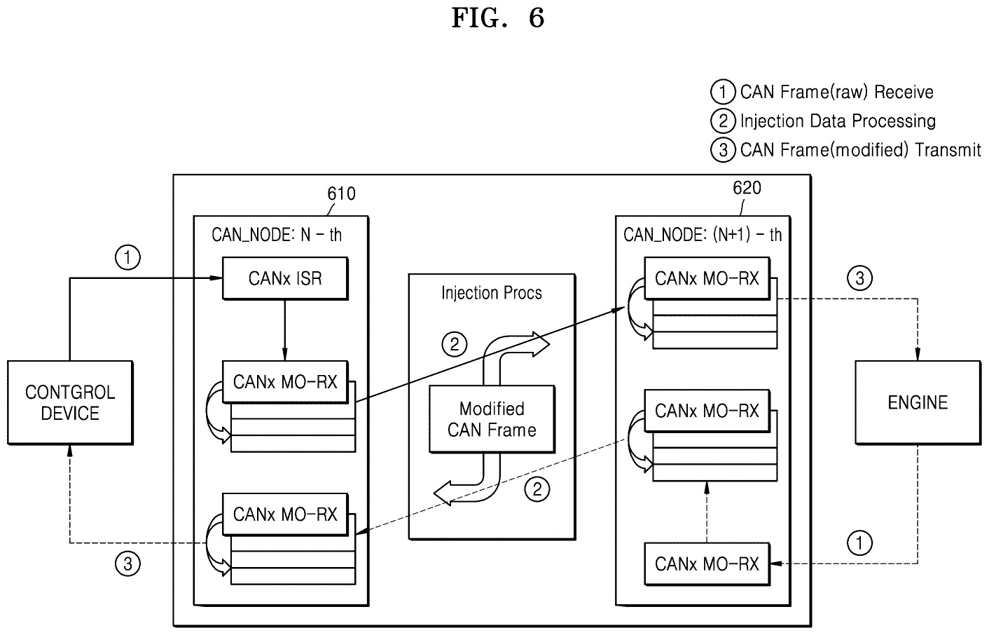

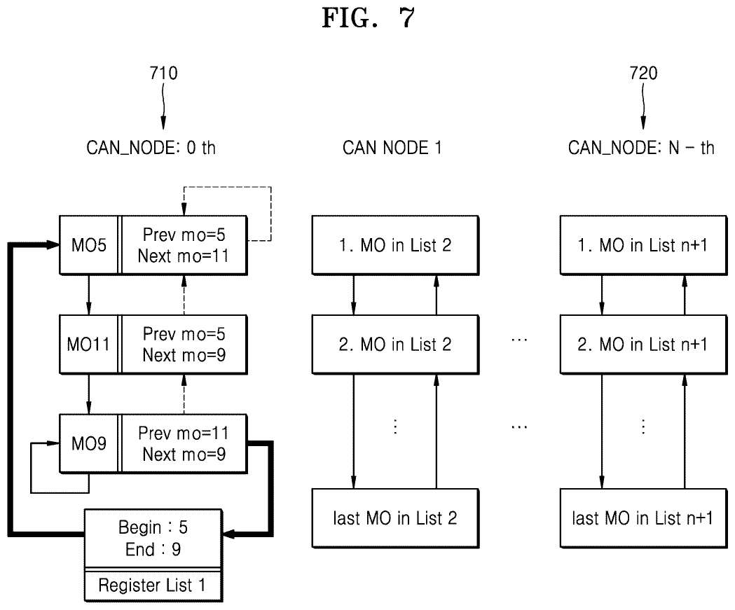

FIG. 6 is a diagram for describing an example of a structure for relaying a message, according to an embodiment. FIG. 7 is a diagram for describing another example of a structure for relaying a message, according to an embodiment. Hereinafter, an example of a structure in which the processor 220 relays a message will be described with reference to FIGS. 6 and 7. That is, a method, performed by an EIU, of relaying a message to an engine will be described.

First, referring to FIG. 6, the processor 220 may relay a message (e.g., a first message or a second message) to the engine by using a structure for circulation of a message object, which processes a CAN frame.

For example, the processor 220 may receive a message from an N-th node 610, transmit the message to an (N+1)-th node 620, and relay the message to an ECU or the engine (here, N is a natural number greater than or equal to 1).

In detail, when the ship is in the autonomous navigation mode, the processor 220 may receive a first message from the N-th node 610, and generate a second message by converting control data included in the first message based on a control value of an instrument. Thus, the processor 220 may relay the generated second message to the (N+1)-th node 620. In other words, the processor 220 may relay the second message to the (N+1)-th node 620 by injecting the second message into the internal communication network.

In addition, when the ship is in the manual navigation mode, the processor 220 may relay the first message received from the N-th node 610 to the (N+1)-th node 620 without converting it.

Here, the processor 220 may relay the first message or the second message from the N-th node 610 to the (N+1)-th node 620 within a predetermined time, such as several hundred micro seconds (us).

Referring to FIG. 7, the processor 220 may relay a message (e.g., a first message or a second message) to the engine differently for each node 710 or 720 using the structure of a message object.

Here, the structure of the message object may be a double linked list structure. The double linked list structure may be a bidirectional cyclic structure in which each node may transmit data to both the previous node and the next node.

For example, the processor 220 may relay messages to the engine by performing dynamic allocation of the messages to the respective nodes according to the loads of the messages. Here, dynamic allocation may refer to distributing nodes to relay messages in accordance with the situation whenever a message needs to be relayed.

For example, the processor 220 may dynamically allocate a message to a zeroth node 710 or an N-th node 720 according to the load of the message. For example, the processor 220 may allocate a message with a low load to the zeroth node 710. As another example, the processor 220 may allocate a message with a high load to the N-th node 720.

Thus, the processor 220 may efficiently relay messages to the engine by dynamically allocating the messages to the respective nodes according to the loads of the messages using the double linked list structure of a message object.

As an additional example, the processor 220 may control the message relay circuit of the internal communication network based on any one of a user input or an error in the autonomous navigation processing device. In detail, the processor 220 may switch the message relay circuit of the internal communication network to directly relay an injected first message to the engine.

According to the present disclosure, even a ship equipped with an arbitrary engine may perform autonomous navigation without any separate measures.

In addition, the ship may navigate efficiently and stably through seamless switching between a manual navigation mode and an autonomous navigation mode.

In addition, even when an error occurs in an autonomous navigation processing device or the like of the ship, the ship may stably navigate through switching of a message relay circuit.

Meanwhile, the above-described method may be written as a computer-executable program, and may be implemented in a general-purpose digital computer that executes the program using a non-transitory computer-readable recording medium. In addition, the structure of the data used in the above-described method may be recorded in a non-transitory computer-readable recording medium through various units. The non-transitory computer-readable recording medium includes a storage medium, such as a magnetic storage medium (e.g., ROM, RAM, a universal serial bus (USB) drive, a floppy disk, or a hard disk) and an optically readable medium (e.g., a CD-ROM or a digital video disc (DVD)).

It will be understood by those skilled in the art that the present disclosure may be implemented in a modified form without departing from the intrinsic characteristics of the descriptions provided above. Therefore, the disclosed methods should be considered in an illustrative rather than a restrictive sense, and the scope of the present disclosure should be defined by claims rather than the foregoing description, and should be construed to include all differences within the scope equivalent thereto.

According to an embodiment of the present disclosure, a control signal may be converted and relayed to an engine regardless of the type of the engine. Accordingly, autonomous navigation of a ship equipped with an arbitrary engine may be enabled without modifying the ship or changing instruments installed in the ship.

In addition, when an abnormality is detected in a device for relaying a message from an autonomous navigation processing device to an engine, an engine control signal that is not converted may be relayed to the engine by switching a circuit configured to relay a message. Therefore, the ship may be operated stably regardless of malfunction of the device for relaying a message from an autonomous navigation processing device to an engine.

The objectives of the present disclosure are not limited to the foregoing, and other objectives that are not mentioned herein will be clearly understood by those skilled in the art from the above description.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of relaying an engine control message to an engine in an engine interface unit comprising a processor and a memory, the method comprising:
based on a navigation mode of a ship being a first mode, relaying, by the processor, a first message to an internal communication network;
in response to the navigation mode of the ship being a second mode, generating, by the processor, a second message by converting the first message stored in the memory; and
injecting, by the processor, the second message into the internal communication network.

2. The method of claim 1, further comprising:
obtaining, by the processor, information associated with the navigation mode of the ship; and
determining, by the processor, the navigation mode of the ship using the obtained information.

3. The method of claim 1, wherein the generating of the second message comprises:
identifying, by the processor, control data included in the first message based on pre-stored data; and
modifying, by the processor, the control data based on a control value that is output from an autonomous navigation processing device.

4. The method of claim 3, wherein the pre-stored data is data extracted from message structures, with each message structure corresponding to each of a plurality of engines.

5. The method of claim 3, wherein the modifying of the control data comprises changing at least one of a plurality of parameters of the control data, based on the control value that is output from the autonomous navigation processing device.

6. The method of claim 5, wherein the plurality of parameters comprise at least one of a byte or bit position, a scale, and an offset.

7. The method of claim 1, further comprising switching, by the processor, a message relay circuit of the internal communication network, based on an error in at least one of an autonomous navigation processing device, software, and the engine interface unit.

8. The method of claim 1, further comprising changing, by the processor, the navigation mode of the ship based on a user input for manipulating at least one control device included in the ship.

9. The method of claim 8, wherein the changing of the navigation mode of the ship comprises:
obtaining, by the processor, the user input for manipulating the at least one control device;
deriving, by the processor, an accumulated value of position changes of the at least one control device, based on the user input; and
changing, by the processor, the navigation mode of the ship based on the accumulated value of the position changes.

10. The method of claim 9, wherein the changing of the navigation mode of the ship based on the accumulated value of the position changes comprises:
determining, by the processor, whether the accumulated value of the position changes is greater than or equal to a preset value; and
in response to determining that the accumulated value of the position changes is greater than or equal to the preset value, changing, by the processor, the navigation mode of the ship from the second mode to the first mode.

11. A non-transitory computer-readable recording medium having recorded thereon a program for causing a computer to execute the method of claim 1.

12. A device comprising:
a memory in which at least one program is stored; and
at least one processor configured to execute the at least one program,
wherein the at least one processor is configured to:
determine whether a navigation mode of a ship is a manual navigation mode or an autonomous navigation mode based on a signal received from an autonomous navigation processing device,
in response to the navigation mode of the ship being the manual navigation mode, output a first message to an internal communication network, and
in response to the navigation mode of the ship being the autonomous navigation mode, generate a second message by converting the first message stored in the memory and then output the second message to the internal communication network.

13. The device of claim 12, wherein the at least one processor is further configured to:
identify control data included in the first message based on pre-stored data, and
generate the second message by changing at least one of a plurality of parameters of the control data.

14. The device of claim 13, wherein the pre-stored data is data extracted from message structures, with each message structure corresponding to each of a plurality of engines, and
the plurality of parameters of the control data comprise at least one of a byte or bit position, a scale, and an offset.

15. The device of claim 13, wherein the at least one processor is further configured to change at least one of the plurality of parameters of the control data, based on a control value that is received from the autonomous navigation processing device, and
the control value that is received from the autonomous navigation processing device comprises an engine control value that is generated using an algorithm included in the autonomous navigation processing device.
